(19) United States
(12) Patent Application Publication
(10) Pub. No.: US 2012/0328912 A1
(43) Pub. Date: Dec. 27, 2012

(54) WINDING ASSEMBLY FOR ELECTROCHEMICAL CELLS, METHODS OF MAKING THE WINDING ASSEMBLY, AND THE ELECTROCHEMICAL CELL

(75) Inventors: Hongbo Zhang, Duluth, GA (US); David Robert Mihara, Cumming, GA (US); Xiangjun Wang, Woodstock, GA (US)

(73) Assignee: EXIDE TECHNOLOGIES, Milton, GA (US)

(21) Appl. No.: 13/527,089

(22) Filed: Jun. 19, 2012

Related U.S. Application Data
(60) Provisional application No. 61/499,828, filed on Jun. 22, 2011.

(51) Int. Cl. H01M 4/00; H01M 4/04; H01M 2/12

(52) U.S. Cl. 429/53; 429/94; 29/623.1

(57) ABSTRACT

A winding assembly including positive and negative electrodes and a separator sheet wound in an overlying relationship such that the separator sheet is positioned between the positive and negative electrodes, and such that an exposed edge of the positive electrode is spaced longitudinally from an unexposed edge of the negative electrode at one end, and such that an exposed edge region of the negative electrode is spaced longitudinally from an unexposed edge of the positive electrode at an opposite end, and wherein a portion of the positive electrode proximate to the exposed edge of the positive electrode comprises a first plurality of apertures and a portion of the negative electrode proximate to the exposed edge of the negative electrode comprises a second plurality apertures.

### CROSS REFERENCE TO RELATED APPLICATION

This application claims priority to co-pending to U.S. provisional application No. 61/499,828, filed 22 Jun. 2011, entitled “WINDING ASSEMBLY FOR ELECTROCHEMICAL CELLS, METHODS OF MAKING THE WINDING ASSEMBLY, AND THE ELECTROCHEMICAL CELL”, which is entirely incorporated herein by reference.

### FIELD OF THE INVENTION

The invention relates general to winding assemblies for electrochemical cells, methods of making the winding assembly and electrochemical cells, and more particularly to winding assemblies for high performance lead-acid electrochemical cells and batteries.

### BACKGROUND OF THE INVENTION

The need for improvements in lead-acid storage batteries is widely recognized. One example of a use in which a better battery is needed is in Hybrid Electric Vehicles (HEVs). A hybrid car may obtain up to 50 miles per gallon using the combination of gasoline and electric motors. The battery packs used in current commercially available hybrid cars such Prius sold by Toyota Motors Corporation are based on nickel-metal hydride chemistries and are expensive.

Accordingly, a continual need exists for improved electrochemical cells for high performance battery applications.

### SUMMARY OF THE INVENTION

Disclosed herein are winding assemblies for electrochemical cells, methods of making the winding assembly and electrochemical cells. In embodiments, the winding assemblies can be used in high performance lead-acid electrochemical cells and batteries.

In one embodiment, a winding assembly for an electrochemical cell, comprises a positive electrode; a negative electrode; a separator sheet, wherein the positive and negative electrodes and the separator sheet are wound in overlying relationship such that the separator sheet is positioned between the positive and negative electrodes, and such that an exposed edge of the positive electrode is spaced longitudinally from an unexposed edge of the negative electrode at one end, and such that an exposed edge region of the negative electrode is spaced longitudinally from an unexposed edge of the positive electrode at an opposite end, and wherein a portion of the positive electrode proximate to the exposed edge of the positive electrode comprises a first plurality of apertures and a portion of the negative electrode proximate to the exposed edge of the negative electrode comprises a second plurality apertures; a first current collector connected to the exposed edge of the positive electrode; and a second current collector connected to the exposed edge of the negative electrode.

In one embodiment, an electrochemical cell, comprises a generally cylindrical container; a liquid acid electrolyte disposed in the generally cylindrical container; a winding assembly disposed in the generally cylindrical container, wherein the winding assembly comprises a positive electrode comprising a lead and a positive electrode active material disposed in a first plurality of grid openings; a negative electrode comprising lead and a negative electrode active material disposed in a second plurality of grid openings; a separator sheet, wherein the positive and negative electrodes and the separator sheet are wound in overlying relationship such that the separator sheet is positioned between the positive and negative electrodes, and such that an exposed edge of the positive electrode is spaced longitudinally from an unexposed edge of the negative electrode at one end, and such that an exposed edge region of the negative electrode is spaced longitudinally from an unexposed edge of the positive electrode at an opposite end, and wherein a portion of the positive electrode proximate to the exposed edge of the positive electrode comprises a first plurality apertures and a portion of the negative electrode proximate to the exposed edge of the negative electrode comprises a second plurality apertures; a first current collector connected to the exposed edge of the positive electrode, wherein the first current collector is void of apertures; and a second current collector connected to the exposed edge of the negative electrode, wherein a the second current collector is void of apertures.

In one embodiment, a method of making a winding assembly for an electrochemical cell, comprises winding a positive and negative electrodes with a separator sheet in overlying relationship such that the separator sheet is positioned between the positive and negative electrode, and such that an exposed edge of the positive electrode is spaced longitudinally from an unexposed edge of the negative electrode at one end, and such that an exposed edge region of the negative electrode is spaced longitudinally from an unexposed edge of the positive electrode at an opposite end, and wherein a portion of the positive electrode proximate to the exposed edge of the positive electrode comprises a first plurality of apertures and a portion of the negative electrode proximate to the exposed edge of the negative electrode comprises a second plurality of apertures; casting a first current collector onto the exposed edge of the positive electrode; and casting a second current collector onto the exposed edge of the negative electrode.

The above-described and other features will be appreciated and understood by those skilled in the art from the following detailed description, drawing, and appended claims.

### BRIEF DESCRIPTION OF THE DRAWINGS

Referring now to the figures, which are exemplary embodiments, and wherein like elements are numbered alike:

FIG. 1 is front perspective view of an embodiment of an electrochemical cell;

FIG. 2 is a cross sectional view of the electrochemical cell of FIG. 1;

FIG. 3 is a partial exploded view of the electrochemical cell of FIG. 1; and

FIG. 4 is detailed partial prospective of the winding assembly of FIG. 3.

### DETAILED DESCRIPTION OF THE INVENTION

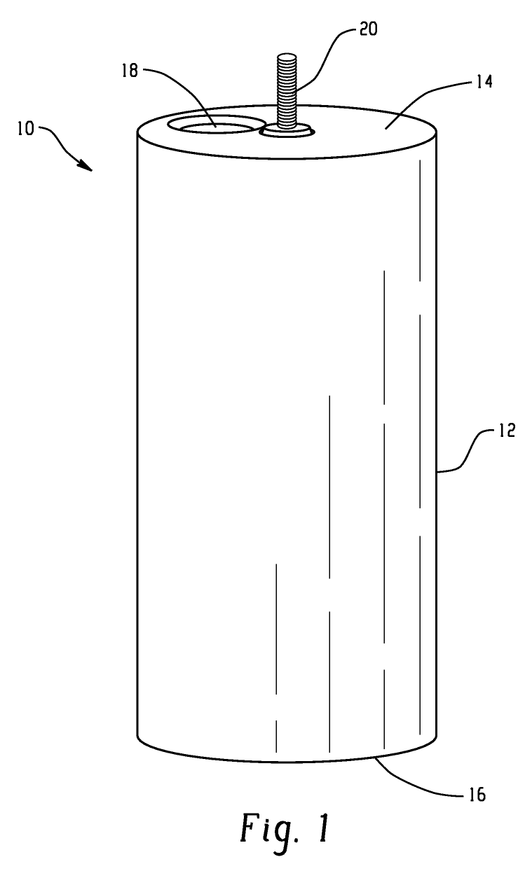

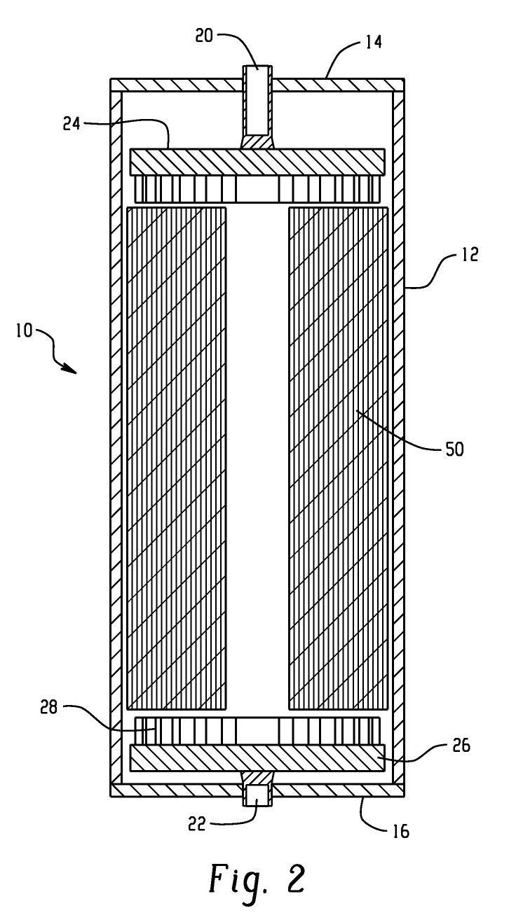

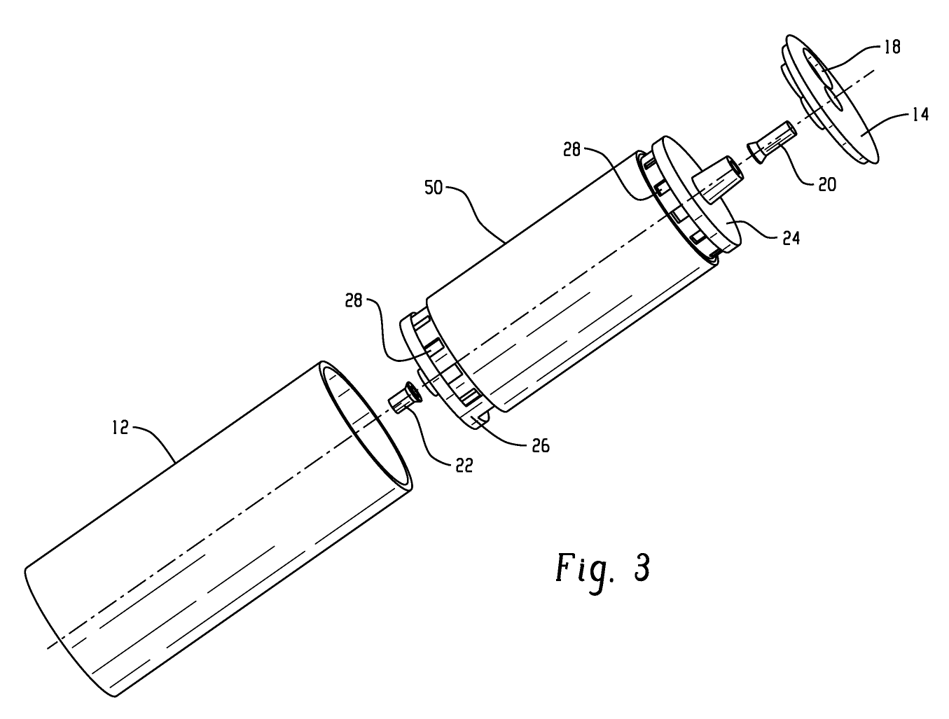

FIGS. 1-3 illustrate one embodiment of an electrochemical cell 10. The electrochemical cell 10 includes a container 12 having a first cover 14 and a second cover 16. The container 12 is illustrated as having a generally cylindrical shape, but other shapes are envisioned (e.g., oval, elliptical). The first cover 14 and the second cover 16 can be affixed to the container by any suitable means. In one embodiment, the first cover 14 and the second cover 16 are ultrasonically welded or adhesively bonded to the container 12. The container 12, the first cover 14 and the second cover 16 comprise a material that is electrically insulative material. Examples of electrically insulative materials included, but are not limited to a polymeric material (e.g., polycarbonate, acrylonitrile-butadiene-styrene, and blends and copolymers of the foregoing) and polymer lined metals.

In one embodiment, as illustrated, the electrochemical cell 10 is a valve-regulated lead-acid (VRLA) design comprising a valve 18 (e.g., a Bunsen valve). The valve 18 can be disposed in an opening formed in the container 12, the first cover 14 and/or the second cover 16. For ease in manufacturing, there may be advantages of disposing the valve 18 in one of the first cover 14 or the second cover 16. The valve 18 comprises an electrically insulative material such as a polymeric material (e.g., ethylene propylene diene Monomer (EPDM) or neoprene rubber).

Metal inserts 20 and 22 with male or female threads are respectively disposed through an opening the first cover 14 and the second cover 16. The placement of the respective metal inserts 20 and 22 within the first cover 14 and the second cover 16 can vary depending on the desired application. The respective metal inserts 20 and 22 can be placed in the same or different relative location within the first cover 14 and the second cover 16. The respective metal inserts 20 and 22 are in electrical communication with respective first current collector 24 and second current collector 26. In one embodiment, the metal inserts 20 and 22 are non-lead to prevent the metal inserts from easily being bent or otherwise being damaged. The metal inserts 20 and 22 facilitate the connection of multiple cells to form a battery (not shown). Suitable materials for the metal inserts 20 and 22 include, but are not limited to, copper, brass and copper containing alloys.

In one embodiment, a winding assembly (sometimes referred to in the art as a “jelly roll”), generally designated 50, is disposed within the container 12. The winding assembly 50 has a size and shape generally corresponding to the size and shape of the container 12. A positive electrode 30 and a negative electrode 32 are disposed in a disposed in a circumferentially wound configuration about an axis in which they are separated from direct contact with one another by separators 36 and 38. As used herein, the term “circumferentially wound” in reference to one or more layers means that the layer defines a path about a central axis in which, for a given angle relative to an imaginary baseline that extends normal to the axis, subsequent layers increase in distance from the axis. The term is intended to include non-circular spiral paths, such as those in which the path formed by a layer is generally elliptical, oblong or oval in shape, as well as spiral paths in which a circumferentially wound circular, elliptical or oval shape is flattened somewhat, such as by the application of pressure from opposite sides.

The positive electrode 30 and the negative electrode 32 each comprise a plurality of apertures adapted to receive an active material paste. The choice of the active material can vary depending on the application. Suitable active materials include sulfated lead oxides pasted used in both the positive electrode 30 and the negative electrode 32.

The thickness of the positive electrode 30 and negative electrode 32 can vary depending on the power density of the battery. For example, for high power density applications, it is desirous to make the positive electrode 30 and the negative electrode 32 as thin as manufacturing capabilities will allow. In one specific embodiment, the positive electrode 30 and the negative electrode 32 are made using ultra-thin grids. The term “ultra-thin” used in reference to the girds refers to a grid having a nominal thickness of less than 0.60 millimeters (mm), specifically, 0.3 mm to 0.6 mm.

The materials for the positive electrode 30 and negative electrode 32 are selected such that they have the capacity to exhibit the desired electrochemical relationship for the generation of electric power. Similarly, the materials for the separators 36, 38 are selected to enhance this electrochemical relationship. The materials for positive electrode 30 and negative electrode 32 and the separators 36, 38 are selected to have a sufficient flexibility and toughness to be successfully circumferentially wound and further processed into the desired shape. Exemplary materials for the positive electrode 30 grid materials include lead-containing materials, such as lead alloys. As used herein, “lead-containing material” means that the material contains at least 50 percent lead by weight; preferred lead-containing materials include at least 70 percent lead by weight. Exemplary materials for the negative electrode 32 grid materials include lead-containing materials such as lead alloys. Exemplary materials for the separators 36, 38 include glass microfibers and organic particularly polymeric materials.

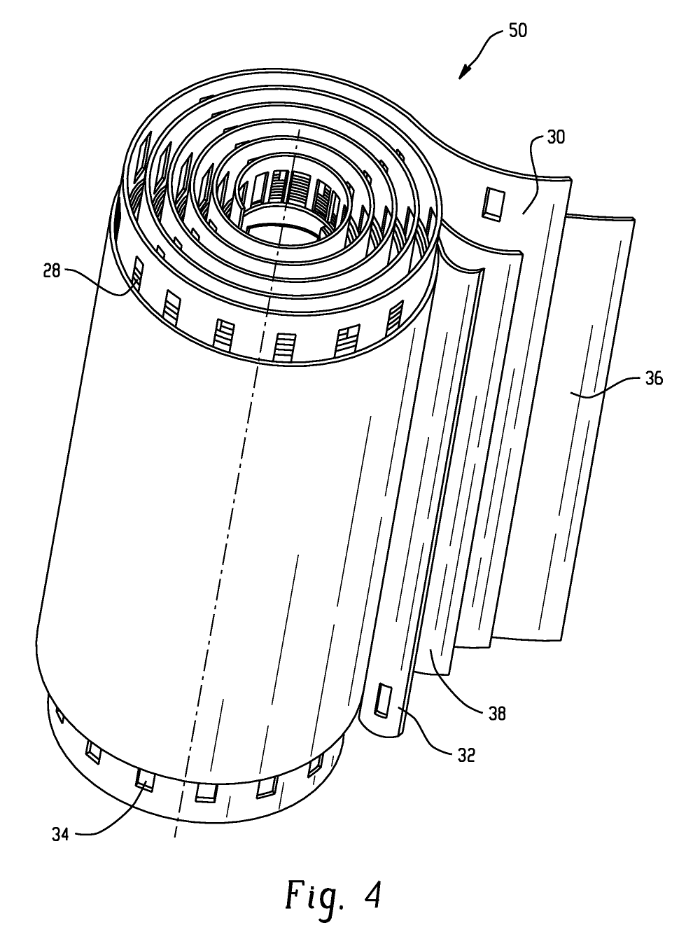

As illustrated in FIG. 4, the positive electrode 30 and negative electrode 32 are circumferentially wound such that a top edge of the positive electrode is longitudinally spaced from the top edge of the negative electrode 32. Similarly, the bottom edge of the negative electrode 32 is longitudinally spaced from the bottom edge of the positive electrode 30. In this configuration, the top edge of the positive electrode 30 is available for electrical communication with first current collector 24 without the negative electrode 32 being in electrical communication therewith. Similarly, the negative electrode 32 can be in electrical communication with second current collector 26 without the second current collector 26 being in electrical communication with the positive electrode 30.

In one embodiment, the positive electrode 30 and the negative electrode 32 each includes a region exposed from the covering of the separators 36, 38 having a respective plurality of apertures 28 adapted to allow electrolyte to flow there-through during a filling operation. The apertures 28 can comprise any number of shapes and sizing including round, square, rectangle, triangle, U-shaped, V-shaped, and X-shaped. The apertures 28 advantageously allow the first current collector and second current collector to be cast-on ends of the winding assembly 50, which can allow for speed in manufacturing production.

In one embodiment, the first current collector 24 and the second current collector 26 are each void of apertures. Without wanting to be bound by theory, it is believed that by having a greater surface of the respective current collector in physical and electrical communication with the edge of a given electrode, higher charging and discharging can be achieved compared to designs with apertures. Furthermore, manufacturing advantages can be obtained by not having to weld the current collector onto the edge of the electrode.

Embodiments disclosed herein advantageously can be used to produce high power density electrochemical cells and batteries. Further, location of apertures in an exposed region of the electrode advantageously allows for ease in manufacturing of the electrochemical cell, which helps in filing the long felt need for lower cost batteries for Hybrid Electric Vehicles (HEVs) applications, for example.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A winding assembly for an electrochemical cell, comprising:
a positive electrode;
a negative electrode;
a separator sheet, wherein the positive and negative electrodes and the separator sheet are wound in overlying relationship such that the separator sheet is positioned between the positive and negative electrodes, and such that an exposed edge of the positive electrode is spaced longitudinally from an unexposed edge of the negative electrode at one end, and such that an exposed edge region of the negative electrode is spaced longitudinally from an unexposed edge of the positive electrode at an opposite end, and wherein a portion of the positive electrode proximate to the exposed edge of the positive electrode comprises a first plurality of apertures and a portion of the negative electrode proximate to the exposed edge of the negative electrode comprises a second plurality apertures;
a first current collector connected to the exposed edge of the positive electrode; and
a second current collector connected to the exposed edge of the negative electrode.

2. The winding assembly according to claim 1, wherein the first current collector is void of apertures.

3. The winding assembly according to claim 1, wherein the second current collector is void of apertures.

4. The winding assembly according to claim 1, wherein the first and second current collectors are each void of apertures.

5. The winding assembly according to claim 1, wherein the positive electrode and the negative electrode each have a thickness of about 0.3 millimeters to 0.6 millimeters.

6. The winding assembly according to claim 1, wherein in the first and second plurality of apertures in the exposed edged portions of each of the respective positive and negative electrodes are selected from the group consisting of circular, square, triangular, and slotted.

7. An electrochemical cell, comprising:
a generally cylindrical container;
a liquid acid electrolyte disposed in the generally cylindrical container;
a winding assembly disposed in the generally cylindrical container, wherein the winding assembly comprises
a positive electrode comprising a lead and a positive electrode active material disposed in a first plurality of grid openings;
a negative electrode comprising lead and a negative electrode active material disposed in a second plurality of grid openings;
a separator sheet, wherein the positive and negative electrodes and the separator sheet are wound in overlying relationship such that the separator sheet is positioned between the positive and negative electrodes, and such that an exposed edge of the positive electrode is spaced longitudinally from an unexposed edge of the negative electrode at one end, and such that an exposed edge region of the negative electrode is spaced longitudinally from an unexposed edge of the positive electrode at an opposite end, and wherein a portion of the positive electrode proximate to the exposed edge of the positive electrode comprises a first plurality apertures and a portion of the negative electrode proximate to the exposed edge of the negative electrode comprises a second plurality apertures;
a first current collector connected to the exposed edge of the positive electrode, wherein the first current collector is void of apertures; and
a second current collector connected to the exposed edge of the negative electrode, wherein a the second current collector is void of apertures.

8. The electrochemical cell according to claim 7, wherein the container further comprises a valve.

9. The electrochemical cell according to claim 8, wherein the valve is a Bunsen valve.

10. The electrochemical cell according to claim 9, further comprising a positive terminal in electrical communication with the first current collector, wherein the positive terminal comprises a non-lead metal insert with male or female threads.

11. The electrochemical cell according to claim 10, further comprising a negative terminal in electrical communication with the second current collector, wherein the negative terminal comprises a non-lead metal insert with male or female threads.

12. The winding assembly according to claim 7, wherein the positive electrode and the negative electrode each have a thickness of about 0.3 millimeters to about 0.6 millimeters.

13. The winding assembly according to claim 7, wherein in the first and second plurality of apertures in the exposed edged portions of each of respective positive and negative electrodes are selected from the group consisting of circular, square, triangular, and slotted.

14. A method of making a winding assembly for an electrochemical cell, comprising:
winding a positive electrode and a negative electrode with a separator sheet in overlying relationship such that the separator sheet is positioned between the positive and negative electrode, and such that an exposed edge of the positive electrode is spaced longitudinally from an unexposed edge of the negative electrode at one end, and such that an exposed edge region of the negative electrode is spaced longitudinally from an unexposed edge of the positive electrode at an opposite end, and wherein a portion of the positive electrode proximate to the exposed edge of the positive electrode comprises a first plurality of apertures and a portion of the negative electrode proximate to the exposed edge of the negative electrode comprises a second plurality of apertures;
casting a first current collector onto the exposed edge of the positive electrode; and
casting a second current collector onto the exposed edge of the negative electrode.

15. The method of making the winding assembly according to claim 14, wherein the first current collector is void of apertures.

16. The method of making the winding assembly according to claim 15, wherein the second current collector is void of apertures.

17. The method of making the winding assembly according to claim 14, wherein the first and second current collectors are each void of apertures.

18. The method of making the winding assembly according to claim 14, wherein the positive electrode and the negative electrode each have a thickness of about 0.3 millimeters to about 0.6 millimeters.

19. The method of making the winding assembly according to claim 14, wherein in the first and second plurality of apertures in the exposed edged portions of each of the respective positive and negative electrodes are selected from the group consisting of circular, square, triangular, and slotted.
